(19) United States
(12) Patent Application Publication
(10) Pub. No.: US 2007/0022031 A1
(43) Pub. Date: Jan. 25, 2007

(54) Transfering financial interest

(75) Inventors: Thomas Sponholtz, Sausalito, CA (US); Ian M. Charles, Tiburon, CA (US); Niels B. Johnson, San Francisco, CA (US); Arthur Bruce Axelson, Washington, DC (US); Peter Salvador Munoz, Oakland, CA (US)

Correspondence Address: VAN PELT, YI & JAMES LLP, 10050 N. FOOTHILL BLVD #200, CUPERTINO, CA, 95014, US

(73) Assignee: Real Estate Equity Exchange Cayman, Inc.

(21) Appl. No.: 11/303,468

(22) Filed: Dec. 16, 2005

Related U.S. Application Data
(60) Provisional application No. 60/700,788, filed on Jul. 19, 2005.

(51) Int. Cl. G06Q 40/00

(52) U.S. Cl. 705/35

(57) ABSTRACT

Transferring a financial interest is disclosed. A fair market value of an asset is assessed in connection with the issuance of an option to buy a portion of the asset. A maximum value of debt associated with the asset is assigned and the option is acquired.

### CROSS REFERENCE TO OTHER APPLICATIONS

This application claims priority to U.S. Provisional Patent Application No. 60/700,788 entitled FINANCIAL INTEREST TRANSFER filed Jul. 19, 2005, which is incorporated herein by reference for all purposes.

### BACKGROUND OF THE INVENTION

Owning an asset enables the asset owner to own any future increase (or decrease) in asset value. Financial gain (or loss) from an increase (or decrease) in asset value is normally realized only when the asset is liquidated. Liquidation of an asset requires finding another party to purchase ownership of the asset. When the asset is sold by the asset owner to another party the asset owner must relinquish ownership of the asset and is no longer able to own any future increase (or decrease) in asset value.

To own an asset, an asset owner must dedicate a portion of his financial resources; commonly, the larger the asset to be acquired, the larger the required portion of the asset owner's financial resources. The owner may, at some point in time following an acquisition of an asset, desire or require some or all of the resources that are tied up in the asset. In order to gain access to some or all of these resources, the owner can sell the asset. In some cases, however, assets cannot be sold quickly or, if they are sold quickly, the asset may not be sold for its full value. Another solution is that the asset owner can borrow money and create a debt using the asset as collateral for the debt. Debt, however, must be paid back and is often associated with periodic payments that, if missed, can result in the forfeiture or forced sale of the asset. It would be useful, therefore, to be able to gain access to some or all of the resources that are tied up in an asset without either (a) creating a debt for which the asset owner is responsible, and (b) without depriving the asset owner of all of the potential for future increase (or decrease) in asset value.

### BRIEF DESCRIPTION OF THE DRAWINGS

Various embodiments of the invention are disclosed in the following detailed description and the accompanying drawings.

FIG. 1 illustrates the portions of value of an asset in one embodiment.

FIG. 2 is a flow chart illustrating an embodiment of a process for transferring a financial interest in an asset.

FIG. 3 illustrates the portions of value of an asset in one embodiment.

FIG. 4 is a flow chart illustrating an embodiment of a process for transferring a financial interest.

FIG. 5A is a flow diagram illustrating an embodiment of a process for transferring a financial interest by issuing an option to acquire a portion of an asset.

FIG. 5B is a flow diagram illustrating an embodiment of a process for transferring a financial interest by issuing an option to acquire a portion of an asset.

FIG. 6A is a flow diagram illustrating an embodiment of a process for transferring financial interest by issuing an option to acquire a portion of an asset.

FIG. 6B is a flow diagram illustrating an embodiment of a process for transferring financial interest by issuing an option to acquire a portion of an asset.

FIG. 7 illustrates the portions of value of an asset in one embodiment.

FIG. 8 is a flow diagram illustrating an embodiment of a process for transferring financial interest and adjusting the value of those interests for value that the owner adds.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Transferring a financial interest is disclosed. A financial interest in an asset is transferred by assessing the fair market value of an asset in connection with the creation and sale, by the asset owner, of an option to buy a portion of the asset. In order to set certain characteristics of the option, the buyer of the financial interest will assign a leverage amount (which, in some embodiments, may be the maximum amount of debt that is or may be associated with the asset). In some embodiments, a portion of the exercise price of the option is prepaid. In some embodiments, the portion of the exercise price of the option that is prepaid is based at least in part on a pricing factor multiplied by the portion of the asset subject to the option and multiplied by a residual value, where the residual value is the fair market value less the leverage amount. In some embodiments, the portion of the asset is adjusted to account for an action of the owner. In various embodiments, the asset comprises real property, personal property (such as fine art, classic automobiles, or mineral ore in the ground), intellectual property, and intangible property.

In some embodiments, the buyer of financial interest in an asset participates asymmetrically with respect to appreciation and depreciation in the fair market value of the asset. In some embodiments, the buyer of financial interest in an asset participates asymmetrically with respect to appreciation (when the asset increases in value) with a relationship defined by a first function and with respect to depreciation (when the asset decreases in value) with a relationship defined by a second function, wherein both the first function and the second function are based at least in part on the fair market value of the asset. In some embodiments, the buyer of financial interest in an asset participates symmetrically with respect to appreciation and depreciation in the fair market value of the asset. In some embodiments, the buyer of financial interest in an asset participates symmetrically with respect to appreciation (when the asset increases in value) and with respect to depreciation (when the asset decreases in value) with a relationship defined by a third function, wherein the third function is based at least in part on the fair market value of the asset. In some embodiments, the buyer of financial interest in an asset participates on a pro rata basis where the participation is directly proportional to the appreciation or depreciation.

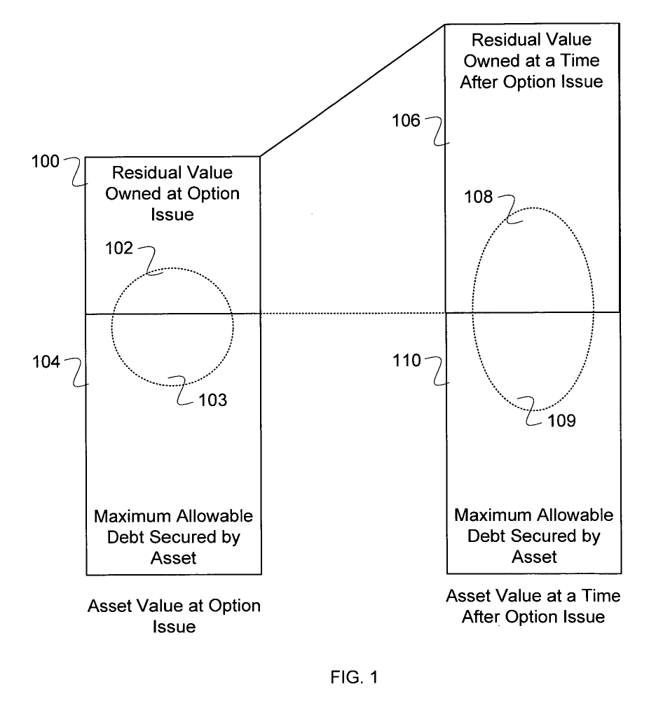

FIG. 1 illustrates the portions of value of an asset in one embodiment. In the example shown, the left bar, which represents the asset value (or the fair market value) at the time when financial interest is created (FMV₁), is comprised of portion 100 and portion 104. Portion 100 is the residual value of the asset owned by the asset owner, which is calculated by subtracting the leverage amount, or the maximum allowable debt secured by the asset at the time financial interest was created, from the fair market value. Portion 104, represented by the lower block in the bar, corresponds to the value of the maximum allowable debt that can be owed by the asset owner that is secured by the asset. Portions 102 and 103 together represent the option portion of the asset that can be purchased from the asset owner by the purchaser of the option. Portion 102 is the option portion of the residual value and portion 103 is the option portion of the maximum allowable debt. The option portion of the asset can be expressed as the Portion Percentage of the asset (for example, PP % of the asset=20% of the asset). In some embodiments, the option portion of the residual value is used to calculate the prepaid portion of the option exercise price. The fair market value of the option portion of the asset is OFMV₁=PP %×FMV₁.

The right bar in FIG. 1, which represents the asset value (or the fair market value) at a time after the financial interest is created and transferred (FMV₂), is also comprised of portion 106 and portion 1 10. Portion 106 is the residual value of the asset owned by the asset owner, which is calculated by subtracting the maximum allowable debt secured by the asset at the time the financial interest was created from the fair market value. Portion 110 represented by the lower block in the bar, corresponds to the value of the maximum allowable debt secured by the asset that can be owed by the asset owner at the time the financial interest was created. Portions 108 and 109 represent the option portion of the asset that can be purchased from the asset owner by the purchaser of the option. Portion 108 is the option portion of the residual value and portion 109 is the option portion of the maximum allowable debt at the time the financial interest was created. The option portion of the asset can be expressed as the Portion Percentage of the asset (for example, PP % of the asset=20% of the asset). The fair market value of the option portion is OFMV₂=PP %×FMV₂. Note that if the fair market value of the asset has changed (increased or decreased), then the value of the Portion Percentage also changes: Option Holder's Value Change=OFMV₂−OFMV₁×PP %×(FMV₂−FMV₁). In some embodiments, if value change for the purchaser of the option is positive and the exercise price for the option was PP %×FMV₁, then the profit to the purchaser of the option is the Option Holder's Value Change. In some embodiments, there are fees that are paid by the asset owner in order to enable the creation and transfer of the financial interest.

In some embodiments, the asset owner has at the time of the creation and transfer of the financial interest a debt of A that is secured by the asset and at some time after the creation and transfer of the financial interest the asset owner may have reduced the debt so that the debt is A′ where A′ is less than A. In some embodiments, the asset owner has at the time of the creation and transfer of the financial interest a debt of B that is secured by the asset and at some time after the creation and transfer of the financial interest the asset owner may have acquired new debt that is secured by the asset so that the new debt is B′ where B′ is more than B. In some embodiments, the asset owner has at the time of the creation and transfer of the financial interest a debt of C that is secured by the asset and at some time after the creation and transfer of the financial interest the asset owner may have the same debt level that is secured by the asset so that the new debt is C′ where C′ is equal to C.

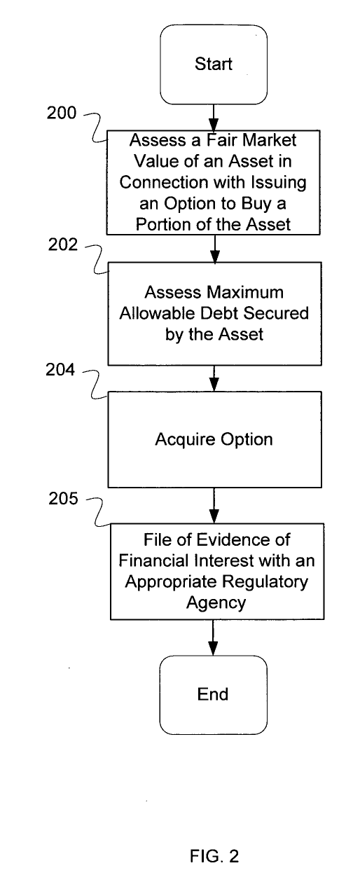

FIG. 2 is a flow chart illustrating an embodiment of a process for transferring financial interest in an asset. In the example shown, in 200 the fair market value of an asset is assessed in connection with transferring financial interest by means of issuing an option to buy a portion of the asset. In some embodiments, a financial interest is created by issuing an option to buy a portion of the asset. In various embodiments, a neutral third party or a market are used to assess the fair market value of the asset. For example, a piece of fine art may be assessed by a museum curator. In some embodiments, the asset is appraised by an appropriate appraiser with experience in valuing the asset in question. For example, a home is appraised by a real estate appraiser. In 202, a maximum allowable debt (MAD) that may be secured by the asset is assigned. The maximum allowable debt is the maximum principal amount of debt secured by the asset that can be owed by the asset owner. For example, in the case of a piece of real estate, this maximum allowable debt would be no greater than the lesser of (a) 100% of the fair market value of the asset at the time financial interest is created or (b) the sum of all mortgages (including equity lines) that could be taken out by the owner and that are secured by the piece of real estate at the time financial interest is created. For another example, a trademark or brand may have associated with it both a future royalty stream as well as a debt with the trademark or brand as collateral. In 204, the option is acquired. In various embodiments, the financial interest is transferred when the option associated with a portion of the asset is acquired or the financial interest is created and transferred when the option associated with a portion of the asset is created and acquired. In 205, the financial interest acquired by the purchaser of the option is secured by filing of evidence of financial interest with an appropriate regulatory agency, the purpose of which is to provide notice of the existence of a financial interest and to ensure primacy of the financial interest in the event of any subsequently created interest in the subject asset.

In various embodiments, the exercise price is not a pro rata, or not a one-to-one, proportion of the fair market value, but rather a multiple, or a function of the fair market value (for example, exercise price=k×PP %×FMV₁, where k is the multiple or exercise price=f{PP %, FMV₁} where f is a function with input parameters PP % and FMV₁ such as exercise price=PP %×PP %×FMV₁×FMV₁). In some embodiments, the owner is prepaid a portion of the exercise price that is not a pro rata, or not a one-to-one, proportion of the portion of the asset associated with the option times the difference between the fair market value of the asset and the maximum allowable debt, but rather a multiple of that expression, prepaid portion of the exercise price=k×PP %×(FMV₁−MAD), where k is the multiple, or a function of PP %, FMV₁, and MAD. In various embodiments, k will vary depending upon inputs from various sources including factors such as the quality of the asset, the quality of the asset owner, the pricing of asset in the market, investor sentiment, and market risk. In some embodiments, the exercise price is a pro rata, or a one-to-one, proportion of the fair market value, or exercise price=PP %×FMV₁. In some embodiments, the owner is prepaid a portion of the exercise price that is a pro rata, or a one-to-one, proportion of the portion of the asset associated with the option times the difference between the fair market value of the asset and the maximum allowable debt, or prepaid portion of the exercise price=PP %×(FMV₁−MAD). In various embodiments, an option exercise price is based at least in part on one or more of: the fair market value of the asset, the maximum value of debt associated with the asset, the portion of the option exercise price that is prepaid, the option holder's percentage participation in the appreciation of the underlying asset, and the option holder's percentage participation in the depreciation of the underlying asset. In some embodiments, the asset owner is able to select the desired values for, prior to pricing the option, one or more of the following: the maximum value of debt associated with the asset, the portion of the option exercise price that is prepaid, the option holder's percentage participation in the appreciation of the underlying asset, and the option holder's percentage participation in the depreciation of the underlying asset.

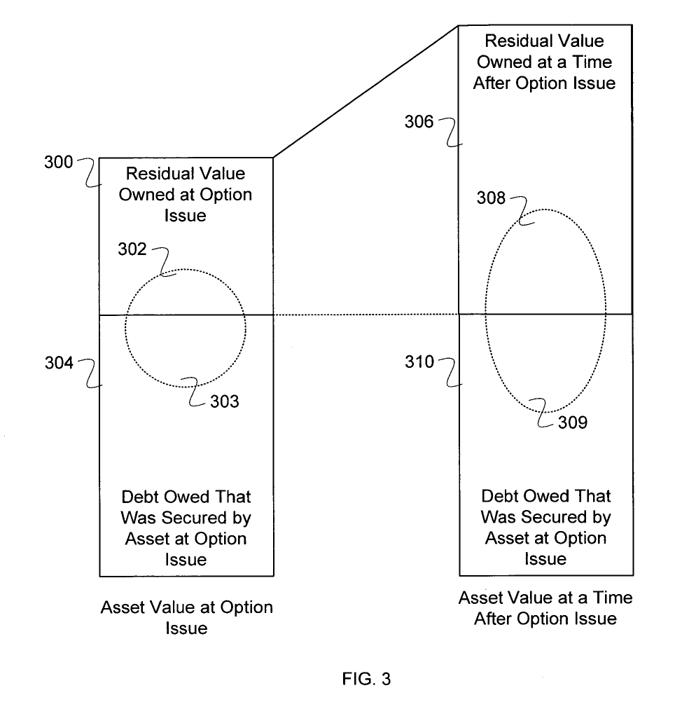

FIG. 3 illustrates the portions of value of an asset in one embodiment. In the example shown, the left bar, which represents the asset value (or the fair market value) at the time when the financial interest is created (FMV₃), is comprised of portion 300 and portion 304. Portion 300 corresponds to the residual value of the asset owned by the asset owner, which is calculated by subtracting the debt secured by the asset from the fair market value of the asset. Portion 304, represented by the lower block in the bar, corresponds to the value of the leverage amount—in this embodiment the debt that is secured by the asset and that is owed by the asset owner. For conceptual purposes, portions 302 and 303 together are used to represent the financial interest created when the asset owner creates an option on that portion of the asset and then sells the option to a purchaser. In this case, portion 302 represents the option portion of the residual value and portion 103 represents the option portion of the debt. The option portion of the asset can be expressed as the Portion Percentage of the asset (for example, PP % of the asset=20% of the asset). In some embodiments, the option portion of the residual value is used to calculate the prepaid portion of the option exercise price, in which case the fair market value of the option portion of the asset is OFMV₁=PP %×FMV₃. In some embodiments, the option is secured by filing a lien against some or all of the asset owner's interest in the asset.

The right bar in FIG. 3, which represents the asset value (or the fair market value) at a time after the financial interest was created and transferred (FMV₄), is comprised of portion 306 and portion 310. Portion 306 corresponds to the residual value of the asset owned by the asset owner, which is calculated by subtracting the debt secured by the asset at the time financial interest was created from the fair market value of the asset at FMV₄. Portion 310, represented by the lower block in the bar, corresponds to the value of the debt was secured by the asset at the time the financial interest was created. For conceptual purposes, portions 308 and 309 are used to represent the portion of the asset that can be purchased from the asset owner by the purchaser of the financial interest. In this case, portion 308 represents the option portion of the residual value and portion 309 represents the option portion of the debt attributable to the asset at the time the financial interest was created. The option portion of the asset can be expressed as the Portion Percentage of the asset (for example, PP % of the asset=20% of the asset). The option fair market value of the option portion is OFMV₄=PP %×FMV₄. Note that if the fair market value of the asset has changed (increased or decreased), then the value of the Portion Percentage also changes: Option Holder's Value Change=OFMV₄−OFMV₃=PP %×(FMV₄−FMV₃). In some embodiments, if the option holder's value change is positive and the exercise price for the option was PP %×FMV₃, then the profit to the acquirer of the financial interest is then the Option Holder's Value Change. In some embodiments, there are fees that are paid by the asset owner in order to enable the creation and sale of the financial interest.

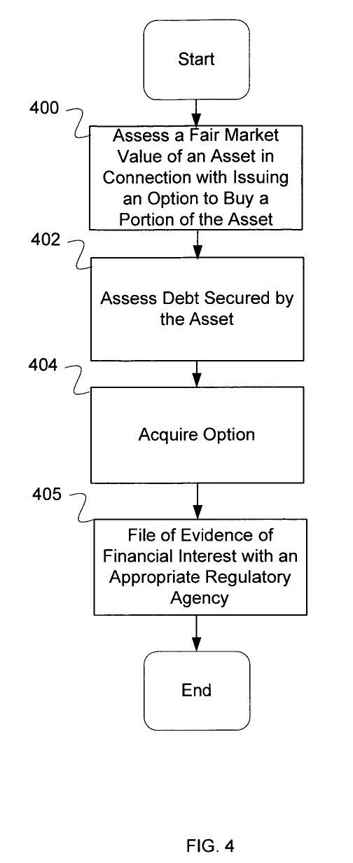

FIG. 4 is a flow chart illustrating an embodiment of a process for transferring financial interest in an asset. In the example shown, in 400 the fair market value of an asset is assessed in connection with transferring a financial interest. In some embodiments, once the fair market value of the asset has been assessed, an option is created with respect to a specified portion of the asset. In various embodiments, an unrelated third party or a reference to a market for such assets or similar assets may be used to assess the fair market value of the asset. For example, a piece of fine art may be assessed by a museum curator. In some embodiments, the asset is appraised by an appraiser with experience in valuing the asset in question. For example, a home is appraised by a real estate appraiser. In 402, the maximum allowable debt (D) that may be secured with the asset is assessed. For example, in the case of a piece of real estate, this debt would be no greater than the lesser of (a) 100% of the fair market value of the asset at the time financial interest is created or (b) the sum of all mortgages (including equity lines) that could be taken out by the owner and that are secured by the piece of real estate at the time financial interest is created. For another example, a trademark or brand may have associated with it both a future royalty stream as well as a debt with the trademark or brand as collateral. In 404, the option is acquired. In various embodiments, the financial interest is created and transferred when the option associated with a portion of the asset is created and acquired, or the financial interest is transferred when the option associated with a portion of the asset is acquired. In 405, the financial interest acquired by the purchaser of the option is secured by filing of evidence of financial interest with an appropriate regulatory agency, the purpose of which is to provide notice of the existence of a financial interest and to ensure primacy of the financial interest in the event of any subsequently created interest in the subject asset. In some embodiments, a lien is filed against the owner's interest in the asset.

In various embodiments, the exercise price is not a pro rata, or not a one-to-one, proportion of the fair market value, but rather a multiple, or a function of the fair market value (for example, exercise price=k×PP %×FMV₃, where k is the multiple or exercise price=f{PP %, FMV₃} where f is a function with input parameters PP % and FMV₃ such as exercise price=PP %×PP %×FMV₃×FMV₃). In some embodiments, the owner is prepaid a portion of the exercise price that is not a pro rata, or not a one-to-one, proportion of the portion of the asset associated with the option times the difference between the fair market value of the asset and the debt, but rather a multiple of that expression, prepaid portion of the exercise price=k×PP %×(FMV₃−D), where k is the multiple, or a function of PP %, FMV₃, and D. In some embodiments, the exercise price is a pro rata, or a one-to-one, proportion of the fair market value, or exercise price=PP %×FMV₃. In some embodiments, the owner is prepaid a portion of the exercise price that is a pro rata, or a one-to-one, proportion of the portion of the asset associated with the option times the difference between the fair market value of the asset and the debt, or prepaid portion of the exercise price=PP %×(FMV₃−D). In various embodiments, an option exercise price is based at least in part on one or more of: the fair market value of the asset, the debt associated with the asset, the portion of the option exercise price that is prepaid, the option holder's percentage participation in the appreciation of the underlying asset, and the option holder's percentage participation in the depreciation of the underlying asset. In some embodiments, the asset owner is able to select the desired values for, prior to pricing the option, one or more of: the debt associated with the asset, the portion of the option exercise price that is prepaid, the option holder's percentage participation in the appreciation of the underlying asset, and the option holder's percentage participation in the depreciation of the underlying asset.

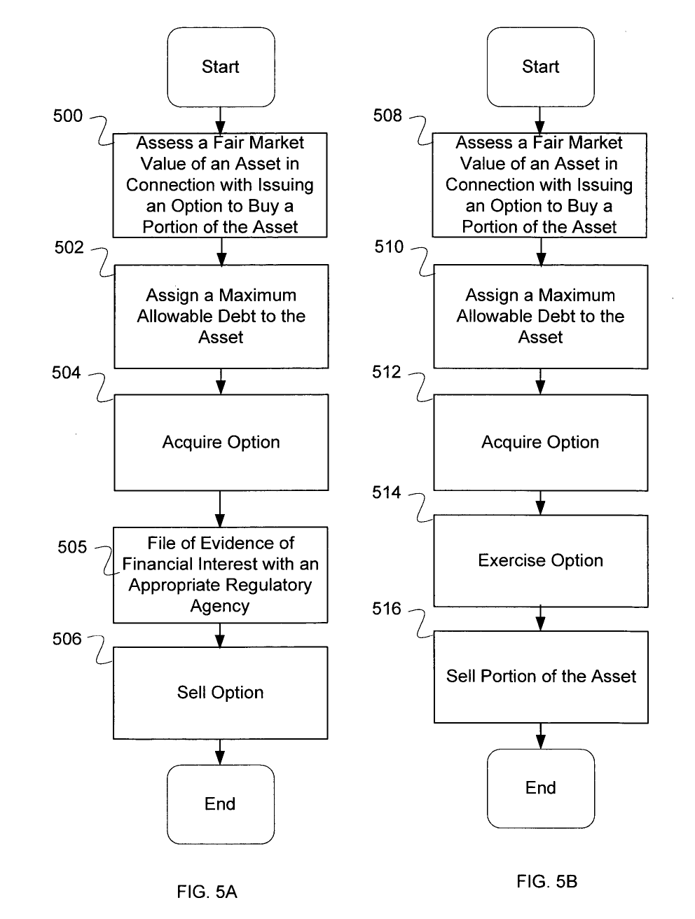

FIG. 5A is a flow diagram illustrating an embodiment of a process for transferring financial interest in an asset by issuing an option to acquire a portion of an asset. In the example shown, 500, 502, 504 and 505 are similar to 400, 402, 404 and 405, respectively of FIG. 4. In 506, the option is sold. In various embodiments, the option is sold or transferred to an affiliated investment manager, an affiliated investment fund, an unrelated third party, another financial entity, a holding company, and/or as part of a group of options. In some embodiments, the option is pooled with other options to create an investment instrument. In some embodiments, the option is repurchased by the asset owner subsequent to the sale or transfer of the option. In some embodiments, selling the option enables the preceding holder of the option to receive cash for the financial interest in the asset.

FIG. 5B is a flow diagram illustrating an embodiment of a process for transferring financial interest in an asset by issuing an option to acquire a portion of an asset. In the example shown, 508, 510, and 512 are similar to 400, 402, and 404, respectively of FIG. 4. In 514, the option is exercised. The remaining portion of the option exercise price is paid to the asset owner in exchange for ownership of the portion of the asset, where the remaining portion of the exercise price is the exercise price less the prepaid portion of the exercise price. In some embodiments, the remaining portion of the exercise price is based at least in part on the exercise price and the prepaid price, where the exercise price is based at least in part on the appreciation of the asset or the depreciation of the asset. In some embodiments, the relation between the exercise price and the remaining portion of the exercise price is asymmetric with respect to appreciation and depreciation so that the remaining portion of the exercise price is a different function for the case when the asset appreciated as compared to when the asset depreciated. In 516, the portion of the asset is sold. In some embodiments, selling the portion of the asset allows the asset owner to receive cash for the financial interest in the asset. In various embodiments, the portion of the asset is sold to the previous asset owner, the portion of the asset is sold to a future asset owner, or the portion of the asset is sold to a financial institution, a holding group, or any other acquirer of assets. In some embodiments, the purchaser of the option prepays a portion of the exercise price proportional to the portion of the asset times the difference between the fair market value of the asset and the maximum allowable debt to which the asset may be subject, and then, at the time of exercise, pays the remainder of the exercise price to exercise the option, where the remainder is proportional to the portion of the asset times the maximum allowable debt to which the asset may be subject, and then sells the portion of the asset. In some embodiments, the purchaser of the option prepays a portion of the exercise price directly proportional to the portion of the asset times the difference between the fair market value of the asset and the maximum allowable debt to which the asset may be subject, and then, at the time of exercise, pays the remainder of the exercise price to exercise the option, where the remainder is directly proportional to the portion of the asset times the maximum allowable debt, and then sells the portion of the asset. In various embodiments, the purchaser of the option prepays a portion of the exercise price where the exercise price depends upon inputs from various sources including factors such as: a quality of the asset, a quality of an owner of the asset, a pricing of asset in a market, an investor sentiment, and a market risk factor.

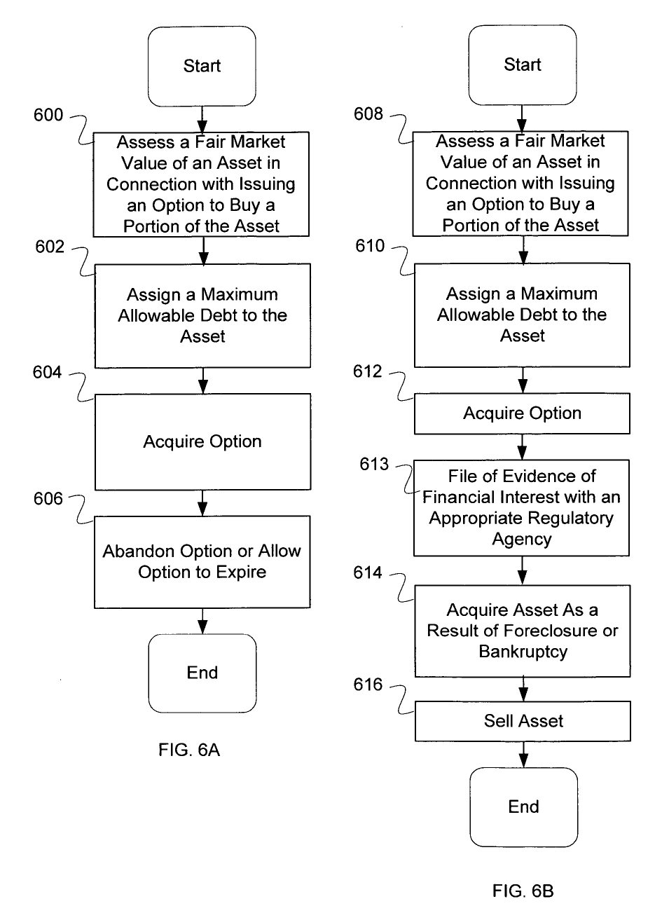

FIG. 6A is a flow diagram illustrating an embodiment of a process for transferring financial interest in an asset by issuing an option to acquire a portion of an asset. In the example shown, 600, 602, and 604 are similar to 400, 402, and 404, respectively of FIG. 4. In 606, the option is abandoned or the option is allowed to expire. In this case, the option is not exercised. In some embodiments, if the option holder's value change is negative and greater than the prepaid portion of the exercise price, then the financial loss that would come about if the option were to be exercised and the portion of the asset were to be acquired can be avoided by abandoning the option or letting the option expire. In some embodiments, the option is abandoned or allowed to expire if there is a liability associated with taking ownership of a portion of the asset. For example, if the land associated with ore in the ground is also contaminated with a toxic substance, then the clean up liability might exceed the value of the ore in the ground.

FIG. 6B is a flow diagram illustrating an embodiment of a process for transferring financial interest in an asset by issuing an option to acquire a portion of an asset. In the example shown, 608, 610, 612, and 613 are similar to 400, 402, 404, and 405 respectively of FIG. 4. In 614, the asset is acquired as a result of a foreclosure or bankruptcy; the regulatory filing described in 613 enables the option holder to acquire the asset in the event of a foreclosure or bankruptcy. In 616, the asset is sold to allow the former option holder to receive cash for the financial interest in the asset.

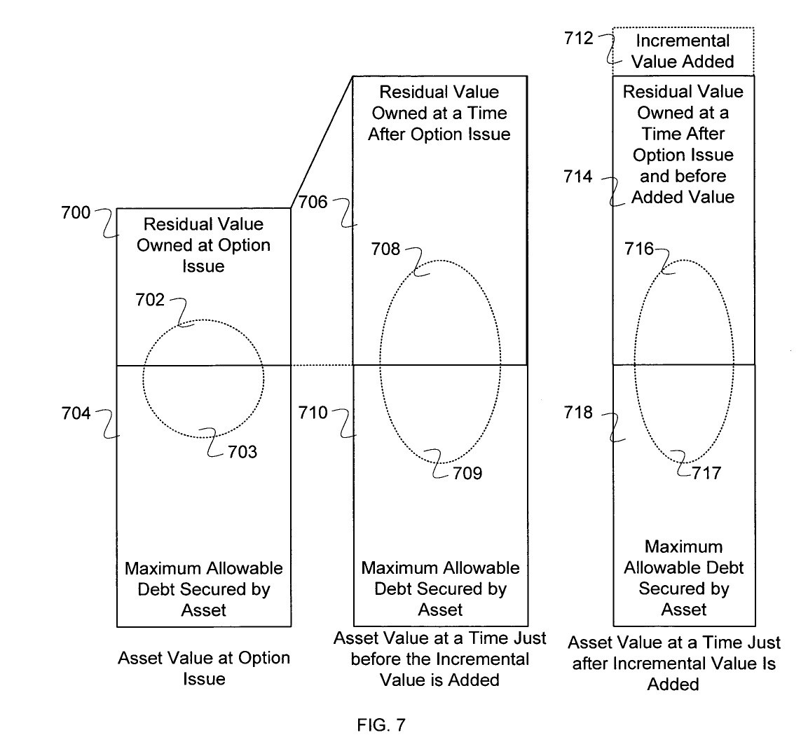

FIG. 7 illustrates the portions of value of an asset in one embodiment. In the example shown, the left bar, which represents the asset value (or the fair market value) at the time when the financial interest is created (FMV₅), is comprised of portion 700 and portion 704. Portion 700 corresponds to the residual value of the asset owned by the asset owner, which is calculated by subtracting the debt secured by the asset from the fair market value. Portion 704, represented by the lower block in the bar, corresponds to the value of the maximum allowable debt to which the asset may be subject that can be owed by the asset owner. For conceptual purposes, portions 702 and 703 together are used to represent the financial interest created when the asset owner creates an option on that portion of the asset and then sells the option to a purchaser. In this case, portion 702 represents the option portion of the residual value and portion 703 represents the option portion of the maximum allowable debt. The option portion of the asset can be expressed as the Portion Percentage of the asset (for example, PP % of the asset=20% of the asset). In some embodiments, the option portion of the residual value is used to calculate the prepaid portion of the option exercise price. The fair market value of the option portion of the asset is OFMV₅=PP %×FMV₅.

The center bar in FIG. 7, which represents the asset value (or the fair market value) at a time after the financial interest is created and the option is issued but before value is added by the owner (FMV₆), is also comprised of two portions: 706 and 710. Portion 706 represents the residual value of the asset owned by the asset owner just before the value is added by the owner, which is calculated by subtracting the maximum allowable debt to which the asset may be subject from the fair market value of the asset at the time of the option issue. Portion 710 represented by the lower block in the bar, corresponds to the value of the maximum allowable debt to which the asset may be subject that can be owed by the asset owner at the time the option was issued. For conceptual purposes, portions 708 and 709 represent the option portion of the asset that can be purchased from the owner by the purchaser of the option. In this case, portion 708 represents the option portion of the residual value and portion 709 represents the option portion of the maximum allowable debt at the time of the option issue. The option portion of the asset can be expressed as the Portion Percentage of the asset (for example, PP % of the asset=20% of the asset). The option fair market value of the option portion is OFMV₆=PP %×FMV₆. Note that if the fair market value of the asset has changed (increased or decreased), then the value of the Portion Percentage also changes: Option Holder's Value Change=OFMV₆−OFMV₅=PP %×(FMV₆−FMV₅). In some embodiments, if the option holder's value change is positive and the exercise price for the option was PP %×FMV₅, then the profit to the acquirer of the option is then the Option Holder's Value Change. In some embodiments, there are fees that are paid by the asset owner in order to enable the option purchase.

The right bar in FIG. 7, which represents the asset value (or the fair market value) at a time after the financial interest is created and the option was issued and after value was added by the owner (FMV₇), is comprised of three portions: 712, 714, and 718. Portion 712 represents the value added by the owner. Portion 714 represents the residual value of the asset owned by the asset owner, which is calculated by subtracting the maximum allowable debt to which the asset may be subject from the fair market value before the value was added by the asset owner, less the maximum allowable debt to which the asset may be subject at the time financial interest is created and the option was issued. Note that portion 712 and portion 714 combined are the residual value owned by the asset owner after the value is added by the asset owner. Portion 718, represented by the lower block in the bar, corresponds to the value of the maximum allowable debt to which the asset may be subject that can be owed by the asset owner at the time the financial interest is created and the option was issued. For conceptual purposes, portions 716 and 717 represent the option portion of the asset that can be purchased from the asset owner by the purchaser of the option. In this case, portion 716 represents the readjusted option portion of the residual value and portion 717 represents the readjusted option portion of the maximum allowable debt at the time the financial interest is created and the option was issued, readjustments required in each case because of the added value. The option portion of the asset can be expressed as the Portion Percentage of the asset (for example, PP % of the asset=20% of the asset). In some embodiments, the portion 708 and the portion 716 have the same value before and after the owner adds value to the asset, and the portion percentage is adjusted so that the value before and after are the same. To account for the value added by the owner, the Portion Percentage is adjusted to PP′ %. The new Portion Percentage can then be easily calculated from PP %×(FMV₆−MAD)=PP′ %×(FMV₇−MAD) so that PP′ %=PP %×(FMV₆−MAD) / (FMV₇−MAD). Note that the fair market value of the option is changed to OFMV₇=PP′ %×FMV₇. In some embodiments, the option value has the same value before and after the value added by the owner, where the option value is represented in FIG. 7 by the entire ellipse 708 and 709 (before value added by owner) in the center bar or 716 and 717 in the right bar (after value added by owner). To account for the value added by the owner, the Portion Percentage is adjusted to PP′ %. The new Portion Percentage can then be easily calculated from PP %×FMV₆=PP′ %×FMV₇ so that PP′ %=PP %×FMV₆/ FMV₇.

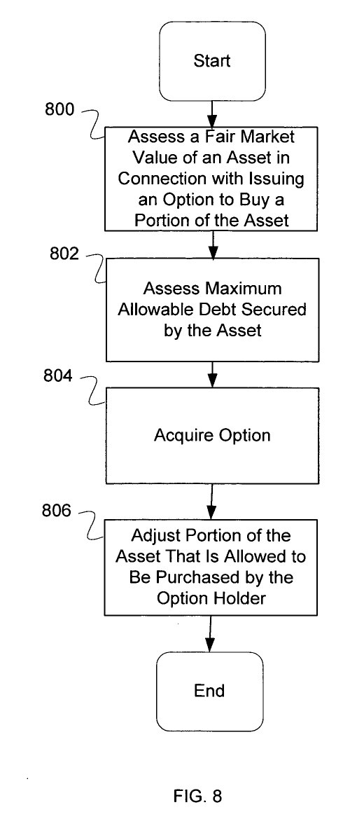

FIG. 8 is a flow diagram illustrating an embodiment of a process for transferring financial interest in an asset and adjusting the value of those interests for value that the owner adds. In the example shown, 800, 802, and 804 are similar to 400, 402, and 404, respectively of FIG. 4. In 806, the portion of the asset that is subject to purchase by the purchaser of the option is adjusted to account for the value added subsequently by the owner. The portion is adjusted based on an assessment of the fair market value of the asset value with the value added by the owner and without the value added by the owner. In various embodiments, the asset is assessed using a neutral party, a market, or an appraiser. In some embodiments, the portion is adjusted so that the option portion of the residual value remains the same before and after the value is added by the owner. In some embodiments, the portion is adjusted so that the value of the option is the same before and after the value is added by the owner.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for transferring financial interest including:
assessing a fair market value of an asset in connection with the issuance of an option to buy a portion of the asset;
assigning a maximum value of debt associated with the asset; and
acquiring the option.

2. A method for transferring financial interest as in claim 1, further including creating a financial instrument.

3. A method for transferring financial interest as in claim 1, wherein acquiring the option includes prepaying a portion of an exercise price of the option.

4. A method for transferring financial interest as in claim 1, further including selling the option.

5. A method for transferring financial interest as in claim 1, further including exercising the option.

6. A method for transferring financial interest as in claim 1, further including exercising the option wherein exercising the option includes paying a remaining portion of an exercise price of the option.

7. A method for transferring financial interest as in claim 1, further including exercising the option and selling the portion of the asset.

8. A method for transferring financial interest as in claim 1, wherein assessing the fair market value of the asset includes an assessment by an unrelated third party.

9. A method for transferring financial interest as in claim 1, wherein assessing the fair market value of the asset includes an assessment by reference to a market for such assets.

10. A method for transferring financial interest as in claim 1, wherein assessing the fair market value of the asset includes appraising the asset.

11. A method for transferring financial interest as in claim 1, wherein acquiring the option includes prepaying a portion of an exercise price of the option, and wherein the value of the portion of the exercise price is based at least in part on the portion of the asset multiplied by an residual value, wherein the residual value is the fair market value of the asset less the maximum allowed debt secured by the asset.

12. A method for transferring financial interest as in claim 1, wherein acquiring the option includes prepaying a portion of an exercise price of the option, and wherein the value of the portion of the exercise price is based at least in part on the portion of the asset multiplied by a residual value, wherein the residual value is the fair market value of the asset less the debt secured by the asset.

13. A method for transferring financial interest as in claim 1, wherein the portion of the asset subject to the option is subsequently adjusted to account for an increase in value of the asset by some action of the asset owner.

14. A method for transferring financial interest as in claim 1, wherein the portion of the asset subject to the option is adjusted to account for an increase in value of the asset by an action of the asset owner based at least in part on the assessed value of the asset including the action of the owner and the assessed value of the asset excluding the action of the owner.

15. A method for transferring financial interest as in claim 1, wherein the option is sold to:
an affiliated investment manager;
an affiliated investment fund; or an unrelated third party.

16. A method for transferring financial interest as in claim 1, wherein the option is repurchased by the asset owner at a time subsequent to the sale of the option.

17. A method for transferring financial interest as in claim 1, wherein the option is pooled with other options to create an investment instrument.

18. A method for transferring financial interest as in claim 1, wherein an option exercise price is based at least in part on one or more of: the fair market value of the asset, the maximum value of debt associated with the asset, the portion of the option exercise price that is prepaid, the option holder's percentage participation in the appreciation of the underlying asset, and the option holder's percentage participation in the depreciation of the underlying asset.

19. A method for transferring financial interest as in claim 1, wherein the option is secured by filing a lien against some or all of the asset owner's interest in the asset.

20. A method for transferring financial interest as in claim 1, wherein an option exercise price is based at least in part on one or more of: a quality of the asset, a quality of an owner of the asset, a pricing of asset in a market, an investor sentiment, and a market risk factor.

21. A method for transferring financial interest as in claim 1, wherein the asset owner selects the desired values for one or more of: the maximum value of debt associated with the asset, the portion of the option exercise price that is prepaid, the option holder's percentage participation in the appreciation of the underlying asset, and the option holder's percentage participation in the depreciation of the underlying asset.
